(19) United States
(12) Patent Application Publication
(10) Pub. No.: US 2020/0236921 A1
(43) Pub. Date: Jul. 30, 2020

(54) SMALL ANIMAL DETERRENT BARRIER

(71) Applicant: TransGard LLC, York, PA (US)

(72) Inventors: Ryan Escure, York, PA (US); William Reichard, York, PA (US)

(21) Appl. No.: 16/671,986

(22) Filed: Nov. 1, 2019

Related U.S. Application Data
(60) Provisional application No. 62/798,798, filed on Jan. 30, 2019.

(51) Int. Cl. A01M 29/24; A01M 29/30

(52) U.S. Cl. CPC A01M 29/24; A01M 29/30

(57) ABSTRACT

A lay-flat barrier has a plurality of modules. Each module has two end pipes attached to each other by one or more connecting pipes to form a frame. Each module also has one or more electrically-conductive mesh panels attached on top of the frame. At least one end pipe of each module is connected to an end pipe of at least one other module. Additionally, the mesh panels of the plurality of modules are adapted to be electrically coupled to each other and to a power source so as to discharge a deterrent amount of current upon contact by a small animal.

### CROSS-REFERENCE TO RELATED APPLICATIONS

This application claims the benefit of priority of U.S. Provisional Patent Application No. 62/798,798, filed on Jan. 30, 2019, which is hereby incorporated herein in its entirety.

### TECHNICAL FIELD

This disclosure relates to a physical barrier. More particularly, the disclosure relates to a lay-flat barrier that deters snakes and other small animals from crossing the barrier. The barrier may have electrical components to produce an electric shock to the intruder to further deter them from crossing the barrier.

### BACKGROUND

Perimeter fencing, including electrified fences, are used to keep trespassers from entering protected areas. To be effective, non-electrified spaces must be smaller than the smallest intruder; otherwise they can avoid or escape the electric deterrent. In the case of electrified fences protecting outdoor structures, such as power stations, the intruder can be a small rodent, or in some environments, a snake. Such small creatures can often pass between the posts of closed gates or under fencing. There is a need for a barrier that addresses crawling creatures such as snakes and other small animals.

### SUMMARY

Some embodiments provide a lay-flat deterrent barrier. The barrier includes two end pipes attached to each other by one or more connecting pipes to form a frame, wherein the frame is configured to be positioned in a lay-flat configuration. The barrier also includes one or more electrically-conductive mesh panels attached to the frame when the frame is in the lay-flat configuration. The mesh panels are adapted to be electrically coupled to a power source so as to discharge a deterrent amount of current, and hence an electrical shock, upon contact by a small animal.

Some other embodiments also provide a lay-flat deterrent barrier. The barrier includes a plurality of modules. Each module includes two end pipes attached to each other by one or more connecting pipes to form a frame. Each module also includes one or more electrically-conductive mesh panels attached on top of the frame. At least one end pipe of each module is connected to an end pipe of at least one other module. Additionally, the mesh panels of the plurality of modules are adapted to be electrically coupled to each other and to a power source so as to discharge a deterrent amount of current upon contact by a small animal.

These and other variants will be appreciated by those of skill in the art upon reading the description below.

Additional features and advantages of this disclosure will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures.

FIG. 1 is a top view of an exemplary small animal deterrent barrier, according to an embodiment;

FIG. 2A is a top view of a traversing module of the barrier of FIG. 1, according to an embodiment;

FIG. 2B is a top view of the traversing module of FIG. 2A, including mesh panel coverings;

FIG. 3A is a top view of a first connecting module of the barrier of FIG. 1, according to an embodiment;

FIG. 3B is a top view of the first connecting module of FIG. 3A, including mesh panel coverings;

FIG. 4A is a top view of a second connecting module of the barrier of FIG. 1, according to an embodiment;

FIG. 4B is a top view of the second connecting module of FIG. 4A, including mesh panel coverings;

FIG. 5A is a top view of a walkway module, according to an embodiment;

FIG. 5B is a perspective view of the walkway module of FIG. 5A, including mesh panel coverings; and

FIG. 6 is a close-up view of a portion of the barrier of FIG. 1, further illustrating an exemplary bracket that may be used to secure modules together and to the ground.

### DETAILED DESCRIPTION

Described herein is a lay-flat physical barrier that provides a horizontal surface which may be electrified, to deter crawling and slithering animals from crossing the barrier. Traditional fences offer some protection, but crawling or slithering animals are often not affected by traditional fences or simply crawl under or around them. The lay-flat physical barrier described herein has a depth sufficient to prevent most crawling or slithering creatures from simply jumping over the barrier and also providing a surface area such that when the animal encounters the barrier, it will receive an electric shock hopefully sending the creature back in the direction from where it came.

The barrier can take many forms, but some embodiments include a modular panel having a frame and an electrified mesh panel covering. In some embodiments, multiple panels can be interconnected to create a larger barrier; typically this is elongated, but any shape could be made. Some panels may form squared corner panels creating a 90° turn, while others can be made to suit other standard or non-standard angles.

The frame of each panel can be made of any material but should be electrically insulative or non-conductive in nature so that the electric charge is isolated to the mesh panel grid, and won't pass to the ground on which the frame sits. Standard 2 inch PVC piping is a suitable material. Other insulative or non-conductive materials such as wood, rubber, plastic, etc., can also be used. In some embodiments, the barrier has a depth of about two feet. This depth makes it wide enough to prevent most small crawling or slithering animals from simply jumping over the barrier, but narrow enough to allow a human to reach across for maintenance or other reasons. Of course, any depth could be used. Similarly, the barrier can be of any length, although with the modular nature, standard lengths of 2, 4, 6, 8, and 10 feet are contemplated. Each module may generally have two end pipes and two connecting pipes, with support pipes therebetween, as needed. The number and spacing of the support pipes will vary based on the dimensions of the barrier itself, keeping in mind that the mesh panel should not sag or touch the ground between pipes.

In at least some embodiments, atop the frame sits a mesh panel, which can be electrified. Any suitable electrically conductive material, such as metal wire, may be used for the mesh paneling. The mesh should be suitable for use outdoors and able to tolerate weather. Because this particular barrier is designed to deter snakes and small animals, a small grid pattern can be used; however there is no limit to the size or diameter of the grid pattern. Larger grid patterns could be used, but larger grids have larger areas where small animals could slip through undeterred.

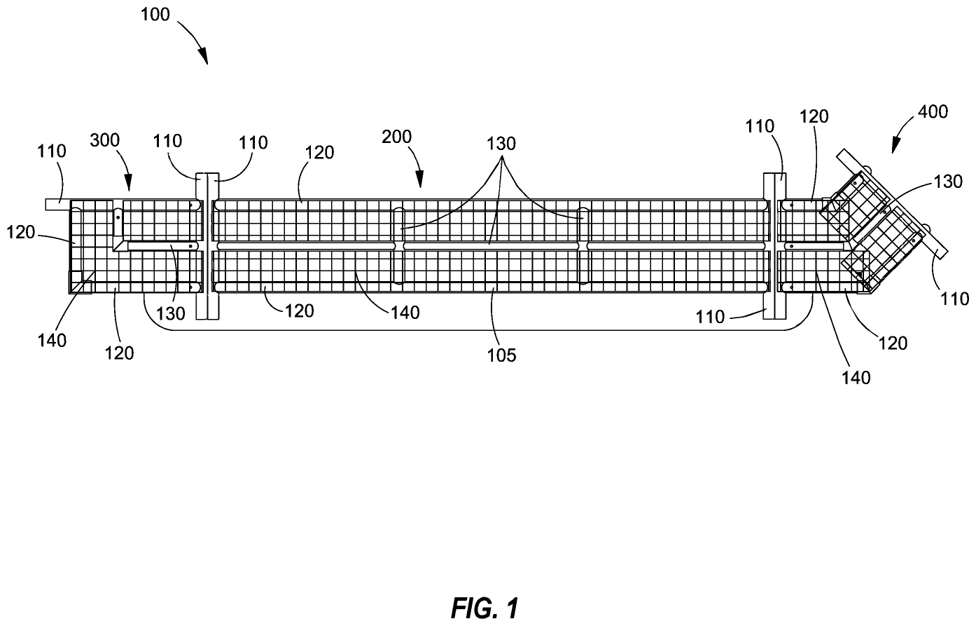

FIG. 1 depicts an exemplary barrier 100, according to an embodiment. As shown, the barrier 100 is modular in design and is comprised of multiple modules 105. In the embodiments shown, each barrier module 105 comprises end pipes 110, connecting pipes 120, and support pipes 130 distributed therebetween. The end pipes 110, connecting pipes 120, and support pipes 130 combine to form a frame that is configured to be arranged in a lay-flat configuration. In the lay-flat configuration, bottom portions of at least some of the pipes are in contact with a substrate, such as the ground. The frame of the barrier 100 lays on the substrate to form a low-height barricade configured to inhibit small animals (and reptiles and snakes) from crossing the boundary formed by the barrier. The end pipes 110, connecting pipes 120, and support pipes 130 may be formed from a non-conductive material. For example, the piping may be PVC pipes connected to each other through PVC fittings.

The barrier may further include one or more mesh panels 140. The mesh panels 140 are arranged on a top of the barrier 100. The top of the barrier 100 is the top of the frame formed by the pipes of each module 105 in the lay-flat configuration. The mesh panels 140 may be formed from a wire grid and be fabricated from an electrically-conductive material. The mesh panels 140 can be coupled to an electrical source (not shown) in order to electrify the wires. For example, the mesh panels may be electrically coupled to a power source so as to discharge a deterrent amount of current upon contact by a small animal (including reptiles and snakes). The modules 105 can be interconnected at their respective end pipes 110, and the mesh panels 140 of each module 105 electrically connected to ensure coverage. In some embodiments, some of the mesh panels are electrically connected to form a negatively charged conducting grid while others are electrically connected to form a positively charged conducting grid.

In an exemplary embodiment, the modules 105 allow the barrier 100 to extend in different directions, such as to follow the outline shape of a boundary (e.g., the boundary around an area to be protected from small animals. The modules 105 may include a traversing module 200 and connecting modules 300, 400. The traversing module 200 may be a lay-flat panel that traverses a straight-line distance in order to create a barrier along a longitudinal length. The first connecting module 300 may add a 90-degree turn to the barrier 100, such as to connect a first traversing module 200 to a second traversing module 200 extending in perpendicular directions to each other. The second connecting module 400 may similarly add a 45-degree turn to the barrier 100.

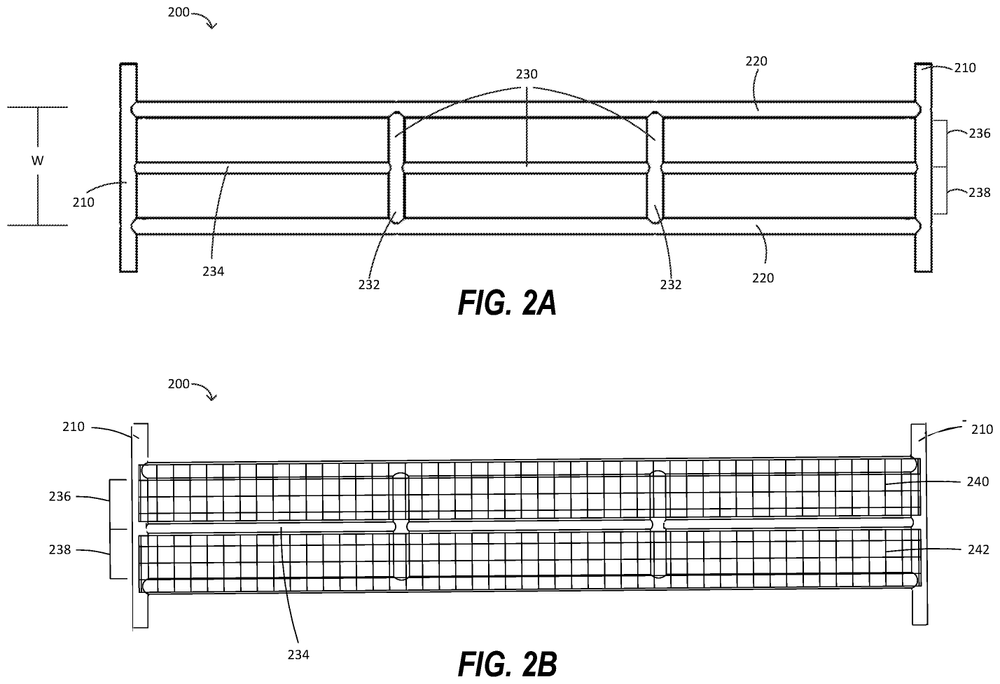

FIGS. 2A and 2B further illustrate an exemplary embodiment of the traversing module 200. The module 200 includes end pipes 210 that are arranged at opposite longitudinal ends of the module 200. The end pipes 210 are arranged parallel to each other and are connected by connecting pipes 220. The connecting pipes 220 extend in the longitudinal direction and traverse between the end pipes 210 to create an outline for the barrier formed by the module 200. The module 200 further includes support pipes 230 interconnected between the end pipes 210 and connecting pipes 220. The support pipes 230 may include support posts 232 and an intermediate rail 234. As shown, the support posts 232 are arranged parallel to the end pipes 210 and the intermediate rail 234 is arranged parallel to the connecting pipes 220. The support posts 232 and intermediate rail 234 may be selected to be smaller in diameter than the end pipes 210 and connecting pipes 220. All of the pipes may be, for example, PVC pipes, or other non-conductive material, according to an embodiment.

A dimension W between the connecting pipes 220 defines a depth of the barrier 100 at the module 200. The depth W defines a front-to-back distance of the module 200 which may be selected to be large enough to prevent small animals from jumping over the barrier. The intermediate rail 234 is preferably centered between the connecting pipes 220 and divides the module 200 into a first section 236 and a second section 238.

As shown in FIG. 2B, mesh panels 240, 242 may be positioned on a top of the module 200. The mesh panels 240, 242 may be metal wire or other conductive material. The mesh panels 240, 242 cover the gaps between the piping of the module 200 and provide a surface that spans a majority of the module 200. The mesh panels 240 may include a first mesh panel 240 positioned at the first section 236 and a second mesh panel 240 positioned at the second section 238, although it should be understood that the first and second mesh panels may be made up of multiple panels themselves, or may comprise a single panel. In one example, the first mesh panel 240 may be electrified as a negatively charged conducting grid and the second mesh panel 242 may be electrified as a positively charged conducting grid, or vice versa. In this embodiment, a small gap is present between the first mesh panel 240 and the second mesh panel 242.

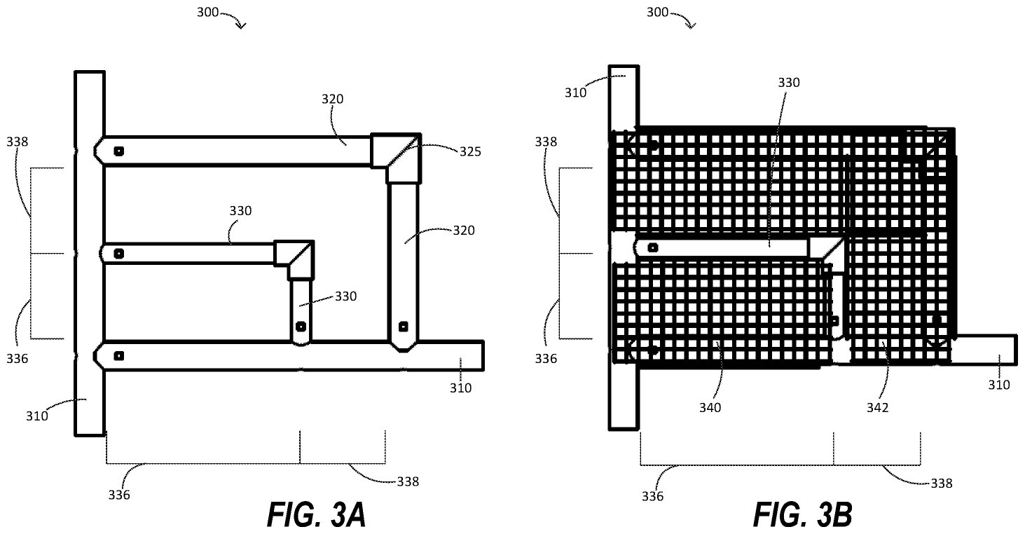

FIGS. 3A and 3B further illustrate an exemplary embodiment of connecting module 300. As shown, the connecting module 300 allows the barrier 100 to take an approximate 90 degree turn. The connecting module 300 includes end pipes 310 and connecting pipes 320. The end pipes 310 are attached to each other at a joint to form a right angle. The connecting pipes 320 are similarly attached to each other, such as through an angled fitting 325. The module 300 further includes support pipes 330 which may be similar to the connecting pipes 320 in that they connect the end pipes 310 to each other. The support pipes 330 may form an intermediate rail that divides the module 300 into a first section 336 and second section 338. The size and arrangement of the piping of the module 300 may be selected to provide dimensions that match the module 200. For example, the spacing of the end pipes 310 and connecting pipes 320 may be selected to maintain the depth W even when the barrier turns 90 degrees as a result of the connection of the module 300.

As shown in FIG. 3B, mesh panels 340, 342 may be attached to a top side of the module 300. The mesh panels 340, 342 may be attached at the first section 336 and the second section 338, respectively. The mesh panels 340, 342 may be continuations of the mesh panels 240, 242 of an adjacently-connected module 200. Due to the shape of the first section 336 and the second section 338, the mesh panels 340, 342 may have different configurations. The “inside track” of the first section 336 may necessitate only a rectangular shape for the first mesh panel 340 while the “outside track” of the second section 338 may necessitate an “L-shaped” second mesh panel 342. The second mesh panel 342 may be made up of two rectangular mesh panels overlapped or positioned to form the L-shape. In one example, the first mesh panel 340 may be electrified as a negatively charged conducting grid and the second mesh panel 342 may be electrified as a positively charged conducting grid, or vice versa. In this embodiment, a small gap is present between the first mesh panel 340 and the second mesh panel 342.

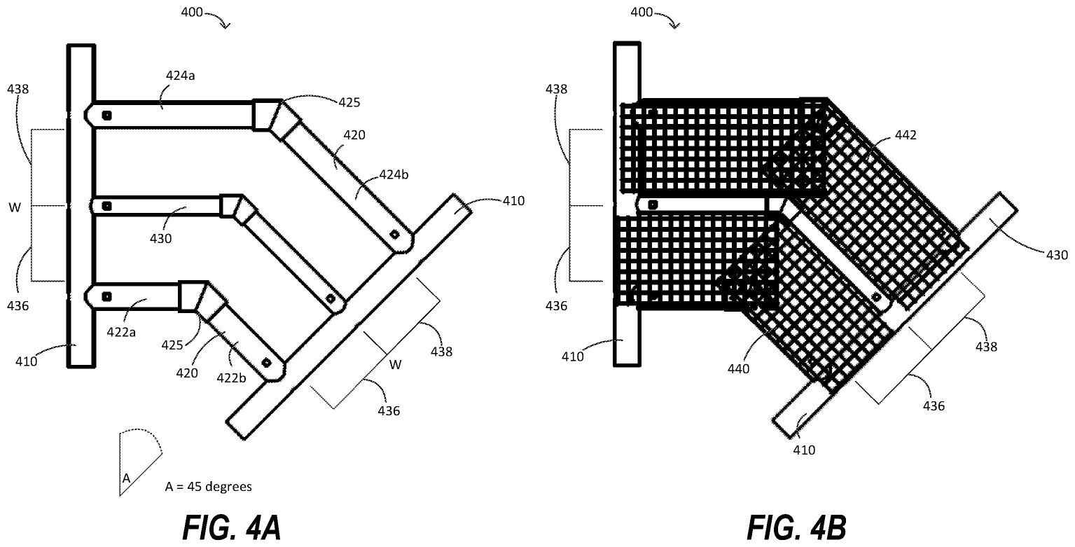

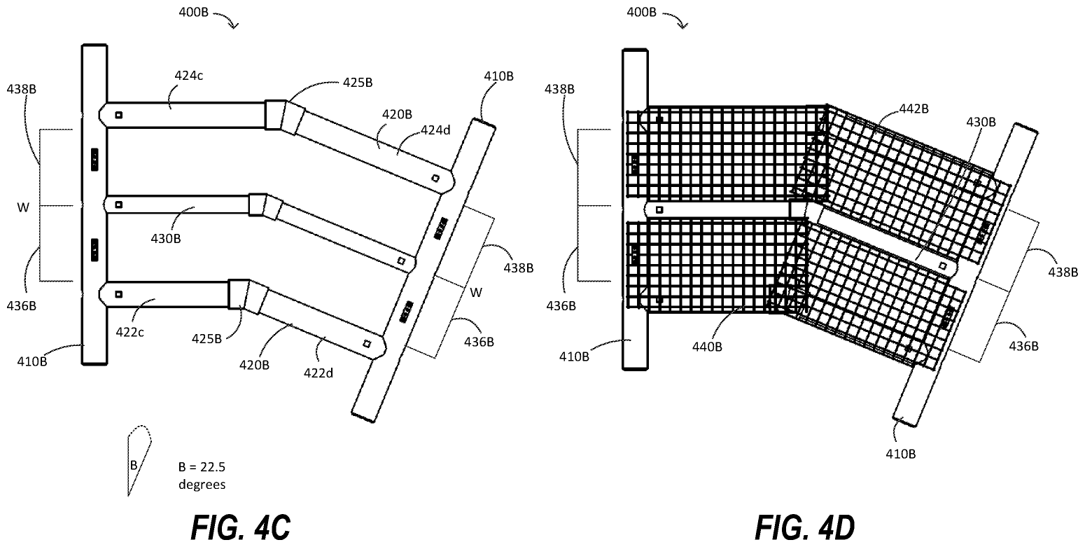

FIGS. 4A and 4B further illustrate an exemplary embodiment of connecting module 400. As shown, the second connecting module 400 allows a 45 degree turn to the barrier 100. The module 400 includes end pipes 410 and connecting pipes 420. The end pipes 410 are arranged at angle A with respect to each other, where A=45 degrees in this embodiment. While a 45 degree angle is illustrated in FIGS. 4A and 4B, it should be understood that the module 400 may be configured to create a turn of any angle A for the barrier 100. For instance, FIGS. 4C and 4D illustrate another embodiment of a connecting module 400B having end pipes 410B formed at an angle of 22.5 degrees.

The connecting pipes 420 may each consist of two sub-component pipes 422a,b and 424a,b that are connected by an angled fitting 425. The angled fitting 425 may be selected such that the sub-component pipes 422a,b and 424a,b attach to the end pipes 410 at right angles. The size and arrangement of the piping of the module 400 may be selected to provide dimensions that match the modules 200 and 300. For example, the spacing of the end pipes 410 and connecting pipes 420 may be selected to maintain a the depth W even when the barrier turns 45 degrees as a result of the connection of the module 400.

The module 400 further includes support pipes 430 which may be similar to the connecting pipes 420 in that they connect the end pipes 410 to each other. The support pipes 430 may form an intermediate rail that divides the module 400 into a first section 436 and second section 438. FIG. 4B further illustrates that mesh panels 440, 442 may be respectively positioned on top of the first section 436 and second section 438 of the module 400. The mesh panels 440, 442 may be continuations of the mesh panels 240, 242 of an adjacently-connected module 200. Each of the mesh panels 440, 442 may be made up of two overlapping rectangular panels that are arranged at an angle to follow the connecting pipes 420 and support pipes 430. In one example, the first mesh panel 440 may be electrified as a negatively charged conducting grid and the second mesh panel 442 may be electrified as a positively charged conducting grid, or vice versa. In this embodiment, a small gap is present between the first mesh panel 440 and the second mesh panel 442.

FIGS. 4C and 4D further illustrate an exemplary embodiment of another connecting module 400B. As shown, the connecting module 400B is similar to the connecting module 400, allowing a 22.5 degree turn to the barrier 100 (instead of the 45 degree turn allowed by the connecting module 400). As disclosed herein, the present disclosure contemplates connecting modules allowing turns of any degree, depending on the needs of the barrier 100. The module 400B includes end pipes 410B and connecting pipes 420B. The end pipes 410B are arranged at angle B with respect to each other, where B=22.5 degrees in this embodiment.

The connecting pipes 420B may each consist of two sub-component pipes 422c,d and 424c,d that are connected by an angled fitting 425B. The angled fitting 425B may be selected such that the sub-component pipes 422c,d and 424c,d attach to the end pipes 410B at right angles. The size and arrangement of the piping of the module 400B may be selected to provide dimensions that match the modules 200 and 300. For example, the spacing of the end pipes 410B and connecting pipes 420B may be selected to maintain a the depth W even when the barrier turns 22.5 degrees as a result of the connection of the module 400B.

The module 400B further includes support pipes 430B which may be similar to the connecting pipes 420B in that they connect the end pipes 410B to each other. The support pipes 430B may form an intermediate rail that divides the module 400B into a first section 436B and second section 438B. FIG. 4D further illustrates that mesh panels 440B, 442B may be respectively positioned on top of the first section 436B and second section 438B of the module 400B. The mesh panels 440B, 442B may be continuations of the mesh panels 240B, 242B of an adjacently-connected module 200. Each of the mesh panels 440B, 442B may be made up of two overlapping rectangular panels that are arranged at an angle to follow the connecting pipes 420B and support pipes 430B. In one example, the first mesh panel 440B may be electrified as a negatively charged conducting grid and the second mesh panel 442B may be electrified as a positively charged conducting grid, or vice versa. In this embodiment, a small gap is present between the first mesh panel 440B and the second mesh panel 442B.

Although pipe fittings may be used to connect the piping of the modules 200, 300, 400, and 400B in some embodiments, pipe joints can be obtained through molding, welding, and other joining techniques to any desired angle.

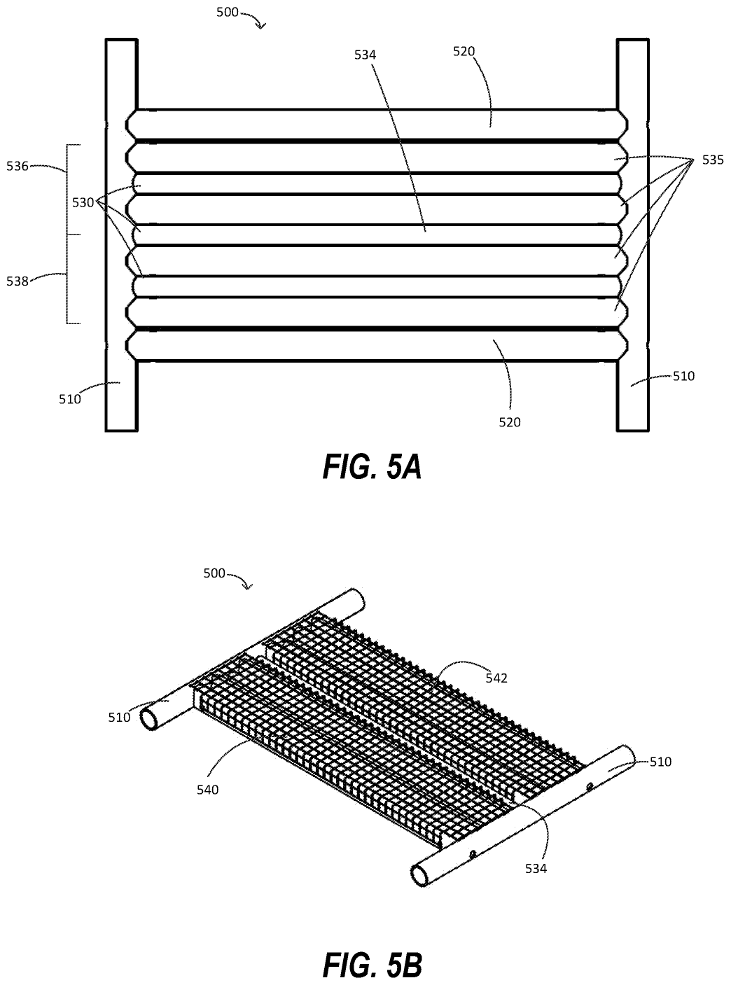

FIGS. 5A and 5B illustrate an exemplary embodiment of a walkway module 500. The module 500 may include end pipes 510 and connecting pipes 520, similar to the end pipes 210 and connecting pipes 220 of the module 200. The end pipes 510 and connecting pipes 520 may form a rectangular outline that may be inserted into the barrier 100, such as at the location of a walkway. However, it should be understood that other shapes are possible, depending on the number and orientation of the end pipes 510 and connecting pipes 520.

The module 500 may further include a plurality of support pipes 530 and filler pipes 535. The support pipes 530 and filler pipes 535 may alternate and abut against each other such that substantially the entire space between the connecting pipes 520 is occupied. A center support pipe 534 may be an intermediate rail that divides the module 500 into a first section 536 and second section 538 The size and arrangement of the piping of the module 500 may be selected to provide dimensions that match the module 200. For example, the spacing of the end pipes 510 and connecting pipes 520 may be selected to maintain the depth W. However, other sizes and configurations are possible.

As shown in FIG. 5B, mesh panels 540, 542 may be positioned on top of the module 500. The mesh panels 540, 542 may be metal wire or other conductive material. The mesh panels 540, 542 cover the gaps between the piping of the module 500 and provide a surface that spans a majority of the module 500. The mesh panels 540, 542 may include a first mesh panel 540 positioned at the first section 536 and a second mesh panel 540 positioned at the second section 538, although it should be understood that the first and second mesh panels may be made up of multiple panels themselves. In one example, the first mesh panel 540 may be electrified as a negatively charged conducting grid and the second mesh panel 542 may be electrified as a positively charged conducting grid, or vice versa. In this embodiment, a small gap is present between the first mesh panel 540 and the second mesh panel 542.

The modules 105 of the barrier 100 may be connected to each other through the joining of end pipes 110. For example an end pipe 210 of a module 200 may be connected to an end pipe 310, 410, or 510 of one of the modules 300, 400, 500, respectively. Or, the end pipe 210 may be connected to an end pipe 210 of another module 200. The modules 105 of barrier 100 may be selected to match the outline of a boundary to be protected by the barrier 100.

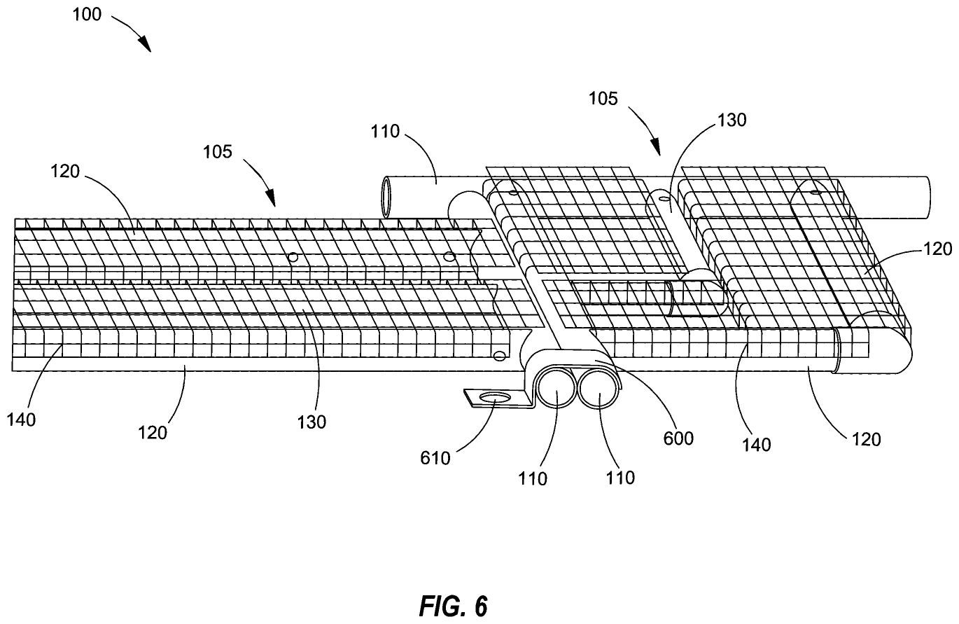

FIG. 6 further depicts a portion of an exemplary barrier 100, including modules 105 with interconnected end pipes 110. The barrier 100 may include a bracket 600 configured to secure at least one of the modules 105 to a substrate, such as the ground, in a lay-flat configuration. The lay-flat configuration may include bottom surfaces of the connecting pipes 120 being in contact with the substrate. In other words, the barrier 100 is arranged such that a plane of the barrier 100 is substantially parallel to the substrate beneath the barrier (e.g., the ground). In order to secure the barrier 100 to the substrate, the bracket 600 may include a hole 610 for receiving a fastener that secures the bracket 600 to the substrate, such as the ground. Other securement means are possible. The bracket 600 may be any form to connect the end pipes 110 and secure the barrier 100 to the substrate. In an embodiment, the bracket 600 may be the bracket described in U.S. Provisional Patent Application Ser. No. 62/798,796, filed on Jan. 30, 2019, entitled Multiple Pipe Bracket by Ryan Escure (Attorney Docket No. 144626.00200), which is incorporated herein by reference in its entirety. One or more brackets 600 may be used throughout the barrier to secure end pipes 110 of different modules 105 to each other and to the substrate.

The lay-flat nature of the modules allows them to withstand high winds and other weather conditions. In some instances, the modular panels can be hurricane-rated. There are no vertical pieces to allow wind to create any lift. Also, the modules themselves can be nestled into the ground/gravel which has the added benefit of minimizing access by crawling animals or wind underneath it. The combination of brackets may combine to require a pull-out force of greater than 400 pounds to lift the barrier from the substrate.

Perimeter fencing such as electrified fencing is helpful in keeping wildlife from entering and damaging outdoor structures such as power plants or electrical sub-stations. When dealing with snakes or other animals that can maneuver through very small cracks, the tolerances become very tight. Disclosed embodiments provide a barrier and method of deterring small animals (including reptiles and snakes) from entering a space using the barrier, including providing an electrified, lay-flat modular barrier that provides an electric shock when its surface is contacted by the small animal.

The term pipe is used herein to mean any elongated structure such as, but not limited to a pipe, a tube, a rod, a post, and is not limited by cross-sectional shape. For example, although this application will reference standard PVC piping, solid rods, and posts having round cross-sectional shapes, squared or oval tubes, pipes, rods, etc., may also be held in place by a bracket having appropriate changes to accommodate the desired cross-sectional shape.

The elements of the figures are not exclusive. Other embodiments may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention.

What is claimed is:

1. A lay-flat barrier comprising:
two end pipes attached to each other by one or more connecting pipes to form a frame, wherein the frame is configured to be positioned in a lay-flat configuration; and
one or more electrically-conductive mesh panels attached on top of the frame when the frame is in the lay-flat configuration,
wherein the mesh panels are adapted to be electrically coupled to a power source so as to discharge a deterrent amount of current upon contact by a small animal.

2. The barrier of claim 1, wherein the end pipes and the one or more connecting pipes are made of a non-conductive material.

3. The barrier of claim 2, wherein the end pipes and the one or more connecting pipes are PVC piping.

4. The barrier of claim 1, further comprising support pipes arranged within the frame.

5. The barrier of claim 4, wherein the support pipes include an intermediate rail that divides the frame into a first section and a second section.

6. The barrier of claim 5, wherein the one or more mesh panels include a first mesh panel attached to the first section and a second mesh panel attached to the second section.

7. The barrier of claim 6, wherein the first mesh panel is electrically connected to form a negatively charged conducting grid and the second mesh panel is electrically connected to form a positively charged conducting grid.

8. The barrier of claim 1, wherein the end pipes are arranged parallel to one another and are connected by opposing parallel connecting pipes.

9. The barrier of claim 1, wherein the end pipes are arranged at an angle with respect to one another.

10. The barrier of claim 9, wherein the end pipes are perpendicular to each other.

11. The barrier of claim 10, wherein the end pipes are connected to each other at a joint to form a right angle.

12. The barrier of claim 9, wherein the connecting pipes include an angled fitting to accommodate the angle of the end pipes and allow the connecting pipes to connect to the end pipes at a right angle.

13. The barrier of claim 9, further comprising support pipes arranged within the frame.

14. The barrier of claim 13, wherein the support pipes include an intermediate rail that divides the frame into a first section and a second section.

15. The barrier of claim 14, wherein the one or more mesh panels include a first mesh panel attached to the first section and a second mesh panel attached to the second section.

16. The barrier of claim 15, wherein the first mesh panel comprises a rectangular shape and the second mesh panel comprises an L-shape.

17. The barrier of claim 1, further comprising a bracket configured to secure the barrier to a substrate in the lay-flat configuration.

18. A lay-flat barrier, comprising
a plurality of modules, each module comprising:
two end pipes attached to each other by one or more connecting pipes to form a frame; and
one or more electrically-conductive mesh panels attached on top of the frame,
wherein at least one end pipe of each module of the plurality of modules is connected to an end pipe of at least one other module of the plurality of modules, and
wherein the mesh panels of the plurality of modules are adapted to be electrically coupled to each other and to a power source so as to discharge a deterrent amount of current upon contact by a small animal.

19. The lay-flat barrier of claim 18, wherein the plurality of modules comprise a first module and a second module,
wherein the first module comprises end pipes that are arranged parallel to each other, and
wherein the second module comprises end pipes that are arranged at an angle with respect to each other.

20. The lay-flat barrier of claim 19, wherein an end pipe of the first module is connected to an end pipe of the second module by a bracket configured to secure the barrier to a substrate.
